(19) United States
(12) Patent Application Publication
(10) Pub. No.: US 2015/0361214 A1
(43) Pub. Date: Dec. 17, 2015

(54) POLYLACTIC ACID COMPOSITION, AND PRODUCTION METHOD AND PRODUCTION APPARATUS OF THE SAME

(71) Applicants: Taichi NEMOTO, Ohta-ku, Tokyo (JP); Chiaki TANAKA, Ohta-ku, Tokyo (JP)

(72) Inventors: Taichi NEMOTO, Shizuoka (JP); Chiaki TANAKA, Shizuoka (JP)

(73) Assignee: Ricoh Company, Ltd., Ohta-ku, Tokyo (JP)

(21) Appl. No.: 14/763,964

(22) PCT Filed: Dec. 25, 2013
(86) PCT No.: PCT/JP2013/085318

§ 371 Date: Jul. 28, 2015

(30) Foreign Application Priority Data
Jan. 28, 2013 (JP) 2013-013078

(51) Int. Cl. C08G 63/08; C08K 5/521; C08G 63/78; C08K 3/34; C08L 67/04; C08K 5/00; C08K 5/09

(52) U.S. Cl. CPC C08G 63/08; C08K 5/0083; C08K 5/521; C08K 5/09; C08K 3/34; C08K 3/346; C08L 67/04; C08G 63/785; C08G 63/78

(57) ABSTRACT

To provide a polylactic acid composition, containing: polylactic acid, wherein the polylactic acid composition contains a ring-opening polymerizable monomer residue in a concentration of 100 ppm by mass to 5,000 ppm by mass, and wherein the polylactic acid composition has a weight average molecular weight of 100,000 or more but less than 300,000 as measured by gel permeation chromatography, a yellow index (YI) value of 5 or less, and a Charpy impact strength of 10 kJ/m² or more.

### TECHNICAL FIELD

The present invention relates to a polylactic acid composition, a production method of the polylactic acid composition, and a production apparatus of the polylactic acid composition.

### BACKGROUND ART

It is a conventionally known method that a polymer is produced through ring-opening polymerization of a ring-opening polymerizable monomer. For example, there is proposed a method for producing polylactic acid by allowing a polymerization raw material containing lactide as a main component to react in a melted state to proceed to polymerization (see PTL 1). In accordance with the proposed method, lactide is reacted to polymerize in the melted state using tin octylate as a catalyst, and setting a reaction temperature to 195° C.

When polylactic acid is produced by the proposed method, however, the resultant polylactic acid contains more than 2% by mass of lactide residues. This is because an equilibrium relationship between a ring-opening polymerizable monomer and a polymer is established in a reaction system of ring-opening polymerization of lactide, and a ring-opening polymerizable monomer tends to be generated by a depolymerization reaction when ring-opening polymerization of a ring-opening polymerizable monomer is performed at high temperature as the aforementioned reaction temperature. The lactide residues function as a catalyst for hydrolysis of a polymer product, or impair thermal resistance of the polymer product.

As for a method for carrying out ring-opening polymerization of a ring-opening polymerizable monomer at low temperature, there is disclosed a polymerization method using supercritical carbon dioxide as a solvent, and using 1,8-diazabicyclo[5.4.0]undec-7-ene (DBU) as a catalyst (see NPL 1). In the disclosed method, lactide is polymerized by, after charging an autoclave with lactide, DBU, and benzyl alcohol, adding carbon dioxide thereto, mixing the mixture at the temperature of 80° C. and the pressure of 70 atm, and further adding carbon dioxide, followed by increasing the pressure to 250 atm. In accordance with this method, a polymer having a number average molecular weight of approximately 10,000 is obtained by reacting for 16 hours.

When a ring-opening polymerizable monomer (e.g., lactide) is polymerized using compressive fluid (e.g., supercritical carbon dioxide) as the solvent, however, there is a problem that polymerization reaction should be performed for a long period of time.

Conventionally, in order to improve physical properties of polylactic acid such as heat resistance, transparency, and impact resistance, a nucleating agent or a crystallization promoter has been added to polylactic acid. As for a method for adding the nucleating agent or the crystallization promoter, there has been commonly performed a method in which pellets consisting of polymerized polymers are melted and kneaded. However, in this melt-kneading method, there is a problem that application of kneading pressure (share) causes occurrence of ring-opening polymerizable monomer residues or thermal decomposition of the resultant polymer, so that the resultant polymer contains the ring-opening polymerizable monomer residues in a large amount.

### CITATION LIST

### Patent Literature

PTL1: Japanese Patent Application Laid-Open (JP-A) No. 08-259679

### Non Patent Literature

NPL 1: Idriss Blakey, Anguang Yu, Steven M. Howdle, Andrew K. Whittakera and Kristofer J. Thurechta, Green Chemistry, 2011, Advance Article

### SUMMARY OF INVENTION

### Technical Problem

The present invention aims to provide a high-quality polylactic acid composition which contains only a small amount of a ring-opening polymerizable monomer residue, which has a high molecular weight and high strength, and which has yellowing resistance.

### Solution to Problem

A means for solving the aforementioned problems is as follows:

A polylactic acid composition, containing:

a polylactic acid,

wherein the polylactic acid composition contains a ring-opening polymerizable monomer residue in a concentration of 100 ppm by mass to 5,000 ppm by mass, and

wherein the polylactic acid composition has a weight average molecular weight of 100,000 or more but less than 300,000 as measured by gel permeation chromatography, a yellow index (YI) value of 5 or less, and a Charpy impact strength of 10 kJ/m² or more.

### Advantageous Effects of Invention

The present invention can solve the above existing problems, and can provide a high-quality polylactic acid composition which contains only a small amount of a ring-opening polymerizable monomer residue, which has a high molecular weight and high strength, and which has yellowing resistance.

### BRIEF DESCRIPTION OF DRAWINGS

FIG. 1 is a general phase diagram depicting the state of a substance depending on pressure and temperature conditions.

FIG. 2 is a phase diagram which defines a compressive fluid used in the present embodiment.

FIG. 3 is a system diagram illustrating one example of the polymerization step in the present embodiment.

### DESCRIPTION OF EMBODIMENTS

### Polylactic Acid Composition

A polylactic acid composition of the present invention contains at least a polylactic acid; preferably a nucleating agent, a crystallization promoter, or both thereof, and, if necessary, other ingredients.

An amount of a ring-opening polymerizable monomer residue contained in the polylactic acid composition is 100 ppm by mass to 5,000 ppm by mass (0.01% by mass to 0.5% by mass), preferably 100 ppm by mass to 1,000 ppm by mass (0.01% by mass to 0.1% by mass). When the amount is more than 5,000 ppm by mass (0.5% by mass), heat resistant stability is deteriorated due to a decrease of a thermal property thereof decrease. Additionally, decomposition of the polylactic acid composition tends to progress because carboxylic acid generated by ring-opening of the ring-opening polymerizable monomer residue functions as a catalyst for accelerating hydrolysis.

Notably, the amount of the ring-opening polymerizable monomer residue can be expressed as a mass ratio, i.e., [mass of ring-opening polymerizable monomer residues/total mass of ring-opening polymerizable monomers (=mass of polylactic acid composition containing ring-opening polymerizable monomer residues)]. The amount of the ring-opening polymerizable monomer residue can be measured based on “Voluntary Standard for Food Containers and Wrappings Formed of Synthetic Resin such as Polyolefin, the third revised edition, added in June, 2004, Part 3, Standard Methods of Analysis for Hygienic Chemists.”

The polylactic acid composition has a weight average molecular weight of 100,000 or more but less than 300,000, preferably 150,000 to 200,000, as measured by gel permeation chromatography.

When the weight average molecular weight is less than 100,000, the polylactic acid composition has unsatisfactory strength. When the weight average molecular weight is 300,000 or more, a nucleating agent and a crystallization promoter, which are added for improving physical properties such as heat resistance, transparency, and impact resistance, may not exert satisfactory effects.

A molecular weight distribution (Mw/Mn), which is a value calculated by dividing the weight average molecular weight (Mw) by a number average molecular weight (Mn), of the polylactic acid composition is not particularly limited and may be appropriately selected depending on the intended purpose, but is preferably 1.0 to 2.5, more preferably 1.0 to 2.0. When the molecular weight distribution (Mw/Mn) is greater than 2.5, there is high possibility that polymerization reaction progresses ununiformly, so that physical properties of the polylactic acid composition may be difficult to be controlled.

The weight average molecular weight and the molecular weight distribution (Mw/Mn) can be measured through gel permeation chromatography (GPC) under the following conditions.

Apparatus: GPC-8020 (product of TOSOH CORPORATION)

Column: TSK G2000HXL and G4000HXL (product of TOSOH CORPORATION)

Temperature: 40° C.

Solvent: Hexafluoroisopropanol (HFIP)

Flow rate: 0.5 mL/min

First, a calibration curve of molecular weight is obtained using monodispersed polystyrene serving as a standard sample. A sample (1 mL) having a concentration of 0.5% by mass is applied and measured under the above conditions, to thereby obtain the molecular weight distribution of the polylactic acid composition. The number average molecular weight (Mn) and the weight average molecular weight (Mw) of the polylactic acid composition are calculated from the calibration curve. The molecular weight distribution is a value calculated by dividing Mw by Mn.

A yellow index (YI) value of the polylactic acid composition is 5 or less, preferably 1 or less. When the YI value is greater than 5, appearance of the polylactic acid composition is impaired. Additionally, physical properties of the polylactic acid composition may be adversely influenced such as a decrease of strength due to heat deterioration.

The yellow index (YI) value can be determined as follows. A 2 mm-thick resin pellet is formed, and is measured for the YI value by means of SM COLOR COMPUTER (product of Suga Test Instruments Co., Ltd.) in accordance with JIS-K7103.

A Charpy impact strength of the polylactic acid composition is 10 kJ/m² or more, preferably 20 kJ/m² or more. When the Charpy impact strength is less than 10 kJ/m², flexibility of the polylactic acid composition is impaired, so that the polylactic acid composition may be difficult to be utilized in applications in which impact resistance is needed (e.g., film).

The Charpy impact strength can be measured as follows. A 10 mm-thick notched specimen is formed from the polylactic acid composition in accordance with ISO 179, and is measured for Charpy impact strength by means of UNIVERSAL IMPACT TESTER (60 kg-cm hammer, product of TOYO SEIKI Co., Ltd.).

### <Polylactic Acid>

The polylactic acid is a kind of aliphatic polyesters of which basic unit is lactic acid, and in which a plurality of lactic acid are linked to thereby have a high molecular weight.

Examples of the polylactic acid include poly-L-lactic acid (PLLA), poly-D-lactic acid (PDLA), a random copolymer of L-lactic acid and D-lactic acid, and a stereo complex of L-lactic acid and D-lactic acid. The polylactic acid may further include other copolymer components, if necessary. These may be used alone or in combination.

Among them, it is preferable to use polylactic acid having a lactic acid component with a high optical purity. It is preferable that an L-isomer or a D-isomer be included at a ratio of 80% or more in a total lactic acid component of the polylactic acid.

The polylactic acid is not particularly limited and may be appropriately selected depending on the intended purpose. The polylactic acid can be synthesized from lactic acid via lactide which is a cyclic dimer of lactic acid by ring-opening polymerization in the presence of a catalyst. The polylactic acid can be produced according to a method for producing a polylactic acid composition described blow.

In the polylactic acid composition, the nucleating agent and the crystallization promoter may be used alone, but it is particularly preferable that they are used in combination from the viewpoint of improving the degree of crystallinity of the polylactic acid composition.

### <Nucleating Agent>

The nucleating agent is not particularly limited and may be appropriately selected depending on the intended purpose, as long as it can improve the polylactic acid composition in the crystallization rate and the degree of crystallinity. It is preferably an organic crystal nucleating agent and/or an inorganic crystal nucleating agent.

### Organic Crystal Nucleating Agent

The organic crystal nucleating agent is not particularly limited and may be appropriately selected depending on the intended purpose. Examples thereof include amide compounds, fatty acid ester compounds, metal salts of amide compounds, hydrazide compounds, organic carboxylic acid metal salt compounds, organic sulfonic acid metal salt compounds, phenylphosphonic acid metal salt compounds, phosphoric acid ester metal salt compounds, rosin acid metal salt compounds, N-substituted ureas, melamine compounds or salts thereof, and uracils. These may be used alone or in combination.

Among them, preferable are phosphoric acid ester metal salt compounds, rosin acid metal salt compounds, carbohydrazides, N-substituted ureas, salts of melamine compounds, and uracils. Particularly preferable are phosphoric acid ester metal salt compounds, and rosin acid metal salt compounds.

Example of a metal salt in the phosphoric acid ester metal salt compounds includes a sodium salt.

Example of the phosphoric acid ester metal salt compounds includes a compound represented by the following Structural Formula (1).

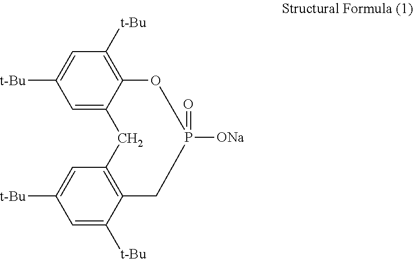

In the Structural Formula (1), t-Bu denotes a t-butyl group.

The phosphoric acid ester metal salt compounds may be commercially available products. Examples thereof include ADEKASTAB NA-11 (the compound represented by the Structural Formula (1)), ADEKASTAB NA-27, and ADEKASTAB NA-5 (all products are of ADEKA CORPORATION).

The rosin acid metal salt compounds may be commercially available products. Examples thereof include PINECRYSTAL KR-50M, KR-612, and KR-614 (all products are of ARAKAWA CHEMICAL INDUSTRIES, LTD.).

### Inorganic Crystal Nucleating Agent

The inorganic crystal nucleating agent is not particularly limited and may be appropriately selected depending on the intended purpose. The inorganic crystal nucleating agent may be fibrous, platy, or powdery. Examples thereof include fibrous inorganic fillers such as glass fiber, asbestos fiber, carbon fiber, potassium titanate whisker, aluminium borate whisker, magnesium-based whisker, silicon-based whisker, wollastonite, sepiolite, asbestos, slag fiber, zonolite, ellestadite, gypsum fiber, silica fiber, silica/alumina fiber, zirconia fiber, boron nitride fiber, and boron fiber; and platy or granular inorganic fillers such as glass flake, non-swelling mica, swelling mica, graphite, metal foil, ceramic bead, talc, clay, mica, sericite, zeolite, bentonite, organically-modified bentonite, montmorillonite, organically-modified montmorillonite, dolomite, smectite, kaolinite, fine powdered silicic acid, feldspar powder, potassium titanate, silas balloon, calcium carbonate, magnesium hydroxide, aluminium hydroxide, magnesium carbonate, barium sulfate, calcium oxide, aluminium oxide, silica, magnesium oxide, titanium oxide, aluminium silicate, silicon oxide, gypsum, novaculite, dawsonite and white clay. These may be used alone or in combination. Among them, preferable are talc, kaolinite, montmorillonite, mica, and wollastonite. Particularly preferable are talc and kaolinite.

A volume average particle diameter (D₅₀) of the nucleating agent is not particularly limited and may be appropriately selected depending on the intended purpose, but is preferably 0.001 μm to 20 μm, more preferably 0.01 μm to 10 μm, further preferably 0.1 μm to 1 μm.

The volume average particle diameter (D₅₀) can be measured by means of laser scattering/diffraction type particle diameter measuring device (LA-920, product of HORIBA, Ltd.).

An amount of the nucleating agent contained in the polylactic acid composition is not particularly limited and may be appropriately selected depending on the intended purpose, but is preferably 0.1 parts by mass to 20 parts by mass, more preferably 1 part by mass to 10 parts by mass, more preferably 1 part by mass to 5 parts by mass, relative to 100 parts by mass of the polylactic acid composition.

### <Crystallization Promoter>

The crystallization promoter is not particularly limited and may be appropriately selected depending on the intended purpose, as long as it can promote crystallization of polylactic acid. Examples thereof include a polyester-based crystallization promoter, a glycerin-based crystallization promoter, a polyvalent carboxylic acid ester-based crystallization promoter, a polyalkylene glycol-based crystallization promoter, an epoxy-based crystallization promoter, and a castor oil-based crystallization promoter.

Examples of the polyester-based crystallization promoter include polyesters formed of an acid component (e.g., adipic acid, sebacic acid, terephthalic acid, isophthalic acid, naphthalene dicarboxylic acid, and diphenyl dicarboxylic acid), and a diol component (e.g., propyleneglycol, 1,3-butanediol, 1,4-butanediol, 1,6-hexanediol, ethyleneglycol and diethyleneglycol); or polyesters formed of hydroxycarboxylic acid such as polycaprolactone. These polyesters may be terminally capped with a monofunctional carboxylic acid or monofunctional alcohol, or may be terminally capped with, for example, an epoxy compound.

Examples of the glycerin-based crystallization promoter include glycerin monoacetomonolaurate, glycerin diacetomonolaurate, glycerin monoacetomonostearate, glycerin diacetomonooleate, glycerin monoacetomonomontanate, glycerin triacetate, and polyglycerol fatty acid ester. An alkylene oxide unit such as ethylene oxide (e.g., polyoxyethylene glycerin triacetate) or propylene oxide may be added to these glycerin-based crystallization promoters.

Examples of the polyvalent carboxylic acid-based crystallization promoter include phthalic esters such as dimethyl phthalate, diethyl phthalate, dibutyl phthalate, dioctyl phthalate, diheptyl phthalate, dibenzyl phthalate or butylbenzyl phthalate; trimellitic esters such as tributyl trimellitate, trioctyl trimellitate or trihexyl trimellitate; succinic esters such as isodecyl succinate, triethyleneglycol monomethyl etherester succinate, or benzylmethyl diglycolester succinate; adipic esters such as diisodecyl adipate, n-octyl-n-decyl adipate, diethyleneglycol monomethyl etherester adipate, methyl diglycol butyldiglycol adipate, benzylmethyldiglycol adipate, adipic acid or benzylbutyldiglycol adipate; azelaic esters such as di-2-ethylhexyl azelate; and sebacic esters such as dibutyl sebacate and di-2-ethylhexyl sebacate. These may be used alone or in combination.

Examples of the polyalkyleneglycol-based crystallization promoter include polyalkylene glycols (e.g., polyethylene glycol, polypropylene glycol, polyethylene glycol/polypropylene glycol copolymer, polytetramethylene glycol, ethylene oxide addition polymer of bisphenols, propylene oxide addition polymer of bisphenols, and tetrahydrofuran addition polymer of bisphenols), or a terminally capped compounds (e.g., a terminal-epoxy modified compound, or a terminal-ether modified compound) thereof. These may be used alone or in combination.

The epoxy-based crystallization promoter generally refers to epoxy triglycerides formed of alkyl epoxy stearate and soybean oil, but in addition to this, those containing bisphenol A and epichlorohydrin as a raw material, so-called an epoxy resin may be also used.

The castor oil-based crystallization promoter is not particularly limited and may be appropriately selected depending on the intended purpose, as long as it is castor oil or derivatives thereof. Examples thereof include castor oil, dehydrated castor oil, hydrogenerated castor oil, castor oil fatty acid, dehydrated castor oil fatty acid, ricinoleic acid, ricinolein acid, 12-hydroxystearate, sebacic acid, undecylenic acid, hepthylic acid, castor oil fatty acid condensates, castor oil fatty acid ester, methyl ricinoleate, ethyl ricinoleate, isopropyl ricinoleate, butyl ricinoleate, ethyleneglycol monoricinoleate, propylene glycol monoricinoleate, trimethylolpropane monoricinoleate, sorbitan monoricinoleate, castor oil fatty acid polyethyleneglycol ester, ethylene oxide adduct of castor oil, castor oil-based polyol, castor oil-based triol, or castor oil-based diol. These may be used alone or in combination.

Among them, preferable are castor oil fatty acid ester, methyl ricinoleate, ethyl ricinoleate, isopropyl ricinoleate, butyl ricinoleate, ethyleneglycol monoricinoleate, propylene glycol monoricinoleate, trimethylolpropane monoricinoleate, sorbitan monoricinoleate, castor oil fatty acid polyethylene glycol ester, ethylene oxide adduct of castor oil, castor oil-based polyol, castor oil-based triol, or castor oil-based diol, from the viewpoint of transparency.

Examples of the other crystallization promoters include polyol esters such as neopentylglycol dibenzoate, diethyleneglycol dibenzoate, triethyleneglycol di-2-ethylbutylate, polyoxyethylene diacetate, polyoxyethylene di(2-ethylhexanoate), polyoxypropylene monolaurate, polyoxypropylene monostearate, polyoxyethylene dibenzoate, and polyoxypropylene dibenzoate; aliphatic carboxylic esters such as butyl oleate; oxylic esters such as acetyl triethyl citrate, acetyl tribuyl citrate, ethoxycarbonylmethyldibutyl citrate, di-2-ethylhexyl citrate, acetyl methyl ricinoleate or acetyl butyl ricinoleate; vegetable oil-based compounds such as soybean oil, soybean oil fatty acid, soybean oil fatty acid ester, epoxidized soybean oil, canola oil, canola oil fatty acid, canola oil fatty acid ester, epoxidized canola oil, linseed oil, linseed oil fatty acid, linseed oil fatty acid ester, epoxidized linseed oil, coconut oil or coconut oil fatty acid; pentaerythritol, sorbitol, polyacrylic acid ester, silicone oil, or paraffins.

The crystallization promoter may be used alone or in combination.

Among them, preferable are polyglycerol fatty acid ester, and polyalkylene glycol-based crystallization promoter. Particularly preferable are polyglycerol fatty acid ester, and polyethylene glycol/polypropylene glycol copolymer.

An amount of the crystallization promoter contained in the polylactic acid composition is not particularly limited and may be appropriately selected depending on the intended purpose, but is preferably 0.1 parts by mass to 20 parts by mass, more preferably 1 part by mass to 10 parts by mass, more preferably 1 part by mass to 5 parts by mass, relative to 100 parts by mass of the polylactic acid composition.

### <Other Ingredients>

The other ingredients are not particularly limited and may be appropriately selected depending on the intended purpose. Examples thereof include a surfactant, a stabilizer, an antioxidant, a UV-ray absorber, a colorant (a pigment, a dye), a releasing agent, an initiator, and a polymerization terminator.

### Surfactant

The surfactant is not particularly limited and may be appropriately selected depending on the intended purpose. Suitably used are those dissolved in the compressive fluid and having compatibility to both the compressive fluid and the ring-opening polymerizable monomer. A use of the surfactant can give effects that the polymerization reaction can be uniformly progressed, and the resultant polylactic acid composition has a narrow molecular weight distribution. In the case where such surfactant is contained in a polymerization system, the surfactant may be added to the compressive fluid, or may be added to the ring-opening polymerizable monomer. In the case where carbon dioxide is used as the compressive fluid, for example, a surfactant having groups having affinity with carbon dioxide and groups having affinity with the ring-opening polymerizable monomer in a molecule thereof is used.

Examples of such surfactant include a fluorosurfactant and a silicone surfactant.

As for the stabilizer, for example, epoxidized soybean oil, or carbodiimide is used.

As for the antioxidant, for example, 2,6-di-t-butyl-4-methyl phenol, or butylhydroxyanisol is used.

As for the pigment, for example, titanium oxide, carbon black, or ultramarine blue is used.

As for the polymerization terminator, for example, benzoic acid, hydrochloric acid, phosphoric acid, metaphosphoric acid, acetic acid or lactic acid is used.

As described above, the polylactic acid composition of the present invention has the amount of a ring-opening polymerizable monomer residue of 100 ppm by mass to 5,000 ppm by mass, the weight average molecular weight of 100,000 or more but less than 300,000 as measured by gel permeation chromatography, the yellow index (YI) value of 5 or less, and the Charpy impact strength of 10 kJ/m² or more. Thus, the polylactic acid composition of the present invention has a high-quality, that is, contains only a small amount of a ring-opening polymerizable monomer residue, has a high molecular weight and high strength, and has yellowing resistance. For example, the polylactic acid composition of the present invention can be widely used in applications such as groceries, industrial materials, agricultural products, medical materials, medicines, cosmetics, electrophotographic toners, packaging materials, electrical equipment materials, housings of household appliances, and automotive materials by forming into, for example, particles, films, sheets, molded products, fibers, or foams.

A polylactic acid composition of the present invention can be produced by the following method for producing a polylactic acid composition and apparatus for producing a polylactic acid composition.

### (Production Method of Polylactic Acid Composition and Production Apparatus of Polylactic Acid Composition)

A method for producing a polylactic acid composition of the present invention includes a polymerization step and a mixing step; and, if necessary, further includes other steps.

An apparatus for producing a polylactic acid composition of the present invention includes a polymerization unit and a mixing unit; and, if necessary, further includes other units.

A method and apparatus for producing a polylactic acid composition of the present invention now will be described.

### <Polymerization Step and Polymerization Unit>

The polymerization step is a step of mixing a ring-opening polymerizable monomer, a compressible fluid, and a nucleating agent to thereby allow the ring-opening polymerizable monomer to ring-opening polymerize in the presence of a catalyst. The polymerization step is performed by a polymerization unit.

The polymerization step may be performed in a continuous manner or in a batch manner, but is preferably performed by a continuous ring-opening polymerization method. The continuous ring-opening polymerization method is a concept in contrast to a method for ring-opening polymerizing per batch, and means for ring-opening polymerizing ring-opening polymerizable monomers in the manner that a polylactic acid composition is continuously obtained. Namely, raw materials such as a ring-opening polymerizable monomer, a nucleating agent, a catalyst, an initiator, and other ingredients can be supplied intermittently, as long as a polylactic acid compound polymerized by ring-opening polymerization can be continuously obtained.

### <<Ring-Opening Polymerizable Monomer>>

The ring-opening polymerizable monomer is not particularly limited and may be appropriately selected depending on the intended purpose. It is preferably lactide which is a cyclic dimer obtained through dehydration condensation of an L-form and/or D form of lactic acid.

### <<Nucleating Agent>>

The nucleating agent may be the same as the nucleating agent in the polylactic acid composition of the present invention.

An amount of the nucleating agent is preferably 0.1 parts by mass to 20 parts by mass, more preferably 1 part by mass to 10 parts by mass, more preferably 1 part by mass to 5 parts by mass relative to 100 parts by mass of the ring-opening polymerizable monomer.

### <<Compressible Fluid>>

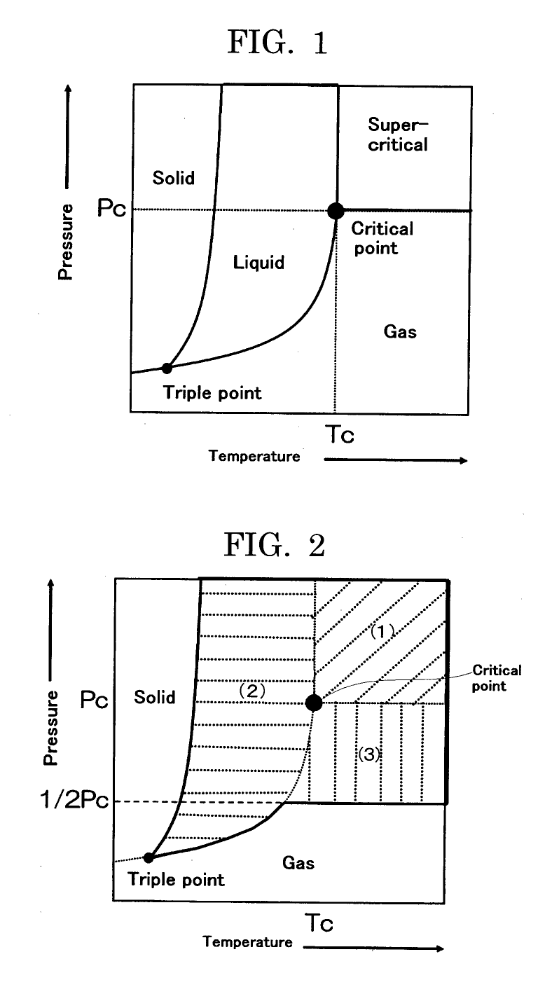

Next, the compressive fluid will be explained with reference to FIGS. 1 and 2. FIG. 1 is a phase diagram depicting the state of a substance depending on pressure and temperature conditions. FIG. 2 is a phase diagram which defines the compressive fluid.

The term “compressive fluid” refers to a state in which a substance is present in any one of the regions (1), (2) and (3) of FIG. 2 in the phase diagram of FIG. 1.

In such regions, the substance is known to have extremely high density and show different behaviors from those shown at normal temperature and normal pressure. Note that, the substance present in the region (1) is a supercritical fluid. The supercritical fluid is a fluid that exists as a non-condensable high-density fluid at temperature and pressure exceeding the corresponding critical points, which are limiting points at which a gas and a liquid can coexist. Also, the supercritical fluid does not condense even when compressed. The substance present in the region (2) is a liquid, but in the present invention, it is a liquefied gas obtained by compressing a substance existing as a gas at normal temperature (25° C.) and normal pressure (1 atm). The substance present in the region (3) is a gas, but in the present invention, it is a high-pressure gas whose pressure is ½ or higher than the critical pressure (Pc) (e.g., ½ Pc or higher).

A substance constituting the compressive fluid includes, for example, carbon monoxide, carbon dioxide, dinitrogen oxide, nitrogen, methane, ethane, propane, 2,3-dimethylbutane, and ethylene. Among them, carbon dioxide is preferable because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used alone or in combination.

In the case where supercritical carbon dioxide is used as a solvent, it has been conventionally considered that carbon dioxide is not suitable for living anionic polymerization, as it may react with basic and nucleophilic substances (see “The Latest Applied Technology of Supercritical Fluid (CHO RINKAI RYUTAI NO SAISHIN OUYOU GIJUTSU),” p. 173, published by NTS Inc. on Mar. 15, 2004). The present inventors, however, have found that, overturning the conventional insight, a polymerization reaction progresses quantitatively in a short time even in the supercritical carbon dioxide by stably coordinating a basic and nucleophilic catalyst with a ring-opening polymerizable monomer to open the ring structure thereof, and as a result, the polymerization reaction progresses livingly. In the present specification, the term “living” means that the reaction progresses quantitatively without a side reaction such as a transfer reaction or termination reaction, so that a molecular weight distribution of the resultant polylactic acid composition is relatively narrow, and is monodispersible.

### <<Catalyst>>

The catalyst is not particularly limited and may be appropriately selected depending on the intended purpose. Examples thereof include an organic catalyst or a metal catalyst.

### Organic Catalyst

The organic catalyst is not particularly limited and may be appropriately selected depending on the intended purpose. Examples thereof include those which does not contain a metal atom, and which contributes to a ring-opening polymerization reaction of the ring-opening polymerizable monomer to form an active intermediate together with the ring-opening polymerizable monomer, and then is removed and regenerated through a reaction with alcohol.

In the case where ring-opening polymerizable monomer having an ester bond is polymerized, the organic catalyst is preferably a basic (and nucleophilic) compound acting as a nucleophilic agent, more preferably a nitrogen atom-containing compound, and particularly preferably a nitrogen atom-containing cyclic compound. Such compound is not particularly limited and may be appropriately selected depending on the intended purpose. Examples thereof include cyclic monoamine, cyclic diamine (e.g., a cyclic diamine compound having an amidine skeleton), a cyclic triamine compound having a guanidine skeleton, a heterocyclic aromatic organic compound containing a nitrogen atom, and N-heterocyclic carbene. Note that, a cationic organic catalyst can be used for the ring-opening polymerization reaction, but the cationic organic catalyst withdraws hydrogen atoms from the polymer backbone (back-biting). As a result, the resultant product tends to have a wide molecular weight distribution, and it is difficult to obtain a high molecular weight product.

Example of the cyclic monoamine includes quinuclidine.

Examples of the cyclic diamine include 1,4-diazabicyclo-[2.2.2]octane (DABCO) and 1,5-diazabicyclo(4,3,0)-5-nonene.

Example of the cyclic diamine compound having an amidine skeleton includes 1,8-diazabicyclo[5.4.0]undec-7-ene (DBU) and diazabicyclo nonene.

Examples of the cyclic triamine compound having a guanidine skeleton include 1,5,7-triazabicyclo[4.4.0]dec-5-ene (TBD) and diphenylguanidine (DPG).

Examples of the heterocyclic aromatic organic compound containing a nitrogen atom include N,N-dimethyl-4-aminopyridine (DMAP), 4-pyrrolidinopyridine (PPY), pyrrocolin, imidazole, pyrimidine and purine.

Examples of the N-heterocyclic carbene include 1,3-di-tert-butylimidazol-2-ylidene (ITBU).

Among them, DABCO, DBU, DPG, TBD, DMAP, PPY, and ITBU are preferable, as they have high nucleophilicity without being greatly affected by steric hindrance, or they have such boiling points that they can removed under the reduced pressure.

Among these organic catalysts, for example, DBU is liquid at room temperature, and has a boiling point. In the case where such organic catalyst is selected, the organic catalyst can be removed substantially quantitatively from the resultant polylactic acid composition by treating the polylactic acid composition under the reduced pressure. Note that, the type of the organic solvent, or whether or not a removal treatment is performed, is determined depending on an intended use of a product.

### Metal Catalyst

The metal catalyst is not particularly limited and may be appropriately selected depending on the intended purpose. Examples thereof include a tin compound, an aluminum compound, a titanium compound, a zirconium compound, and an antimony compound.

Examples of the tin compound include tin octylate, dibutyltin acid, and tin di(2-ethylhexanoate).

Examples of the aluminum compound include aluminum acetylacetonate, and aluminum acetate.

Example of the titanium compound includes tetraisopropyl titanate and tetrabutyl titanate.

Example of the zirconium compound includes zirconium isopropyloxide.

Example of the antimony compound includes antimony trioxide.

A type and an amount of the catalyst for use cannot be determined unconditionally as it varies depending on a combination of the compressive fluid and the ring-opening polymerizable monomer, but it is preferably 0.01 mol % to 15 mol %, more preferably 0.1 mol % to 1 mol %, and particularly preferably 0.3 mol % to 0.5 mol %, relative to 100 mol % of the ring-opening polymerizable monomer. When the amount thereof is smaller than 0.1 mol %, the catalyst is deactivated before completion of the polymerization reaction, and as a result a polylactic acid composition having a target molecular weight cannot be obtained in some cases. When the amount thereof is greater than 15 mol %, it may be difficult to control the polymerization reaction.

The catalyst used in the polymerization step is suitably the organic catalyst (organic catalyst which does not contain a metal atom) in an application in which safety and stability of the resultant product are needed.

### <<Other Ingredients>>

The other ingredients are not particularly limited and may be appropriately selected depending on the intended purpose. Examples thereof include an initiator, a surfactant, a stabilizer, an antioxidant, a pigment, and a polymerization terminator.

### Initiator

The initiator is used for controlling a molecular weight of a polylactic acid obtained by a ring-opening polymerization. The initiator is not particularly limited and may be appropriately selected depending on the intended purpose. In the case of an alcohol-based initiator, for example, mono-, di-, or poly-hydric alcohol of aliphatic alcohol may be used. The initiator may be saturated or unsaturated.

Examples of the initiator include: monoalcohols, polyhydric alcohols, and lactic acid esters. Examples of the monoalcohols include methanol, ethanol, propanol, butanol, pentanol, hexanol, heptanol, nonanol, decanol, lauryl alcohol, myristyl alcohol, cetyl alcohol, and stearyl alcohol. Examples of the polyhydric alcohols include dialcohols such as ethylene glycol, 1,2-propanediol, 1,3-propanediol, 1,3-butanediol, 1,4-butanediol, hexanediol, nonanediol, tetramethylene glycol and polyethylene glycol; glycerol, sorbitol, xylitol, ribitol, erythritol, and triethanolamine. Examples of the lactic acid esters include methyl lactate, and ethyl lactate. These may be used alone or in combination.

Also, polylactic acid having an alcohol residue at a terminal of polycaprolactone diol or polytetramethylene glycol may be used as the initiator. A use of such polylactic acid enables synthesis of diblock copolymers and triblock copolymers.

An amount of the initiator for using in the polymerization step may be appropriately adjusted depending on a target molecular weight of the resultant product, but it is preferably 0.1 mol % to 5 mol % relative to 100 mol % of the ring-opening polymerizable monomer. In order to prevent polymerization from being initiated unevenly, the initiator is preferably sufficiently mixed with the ring-opening polymerizable monomer in advance that the ring-opening polymerizable monomer is brought into contact with a catalyst.

### <Mixing Step and Mixing Unit>

The mixing step is a step of adding a crystallization promoter to a polymer obtained in the polymerization step, and mixing the crystallization promoter and the polymer together. The mixing step is performed by a mixing unit.

The mixing unit is not particularly limited and may be appropriately selected depending on the intended purpose. Examples thereof include a bi- or multi-axial stirring device having screws engaging with each other, stirring elements of 2-flights (ellipse), stirring elements of 3-flights (triangle), or circular or multi-leaf shape (clover shape) stirring wings; and a motionless mixer.

The mixing step is preferably continuously performed subsequently to the polymerization step. The term “continuously” is a concept in contrast to a method for crystallizing per batch, and means continuously adding crystallization promoter to a polymer obtained in the polymerization step, and mixing the crystallization promoter and the polymer together.

### <<Crystallization Promoter>>

The crystallization promoter may be the same as the crystallization promoter in the polylactic acid composition of the present invention.

An amount of the crystallization promoter is preferably 0.1 parts by mass to 20 parts by mass, more preferably 1 part by mass to 10 parts by mass, more preferably 1 part by mass to 5 parts by mass relative to 100 parts by mass of the polymer.

### <Other Steps and Other Units>

The other steps are not particularly limited and may be appropriately selected depending on the intended purpose. Examples thereof include a cooling step and a drying step.

The other units are not particularly limited and may be appropriately selected depending on the intended purpose. Examples thereof include a cooling unit and a drying unit.

An apparatus for producing a polylactic acid composition of the present invention (a polymerization reactor) used in a method for producing a polylactic acid composition of the present invention will be explained with reference to the figure.

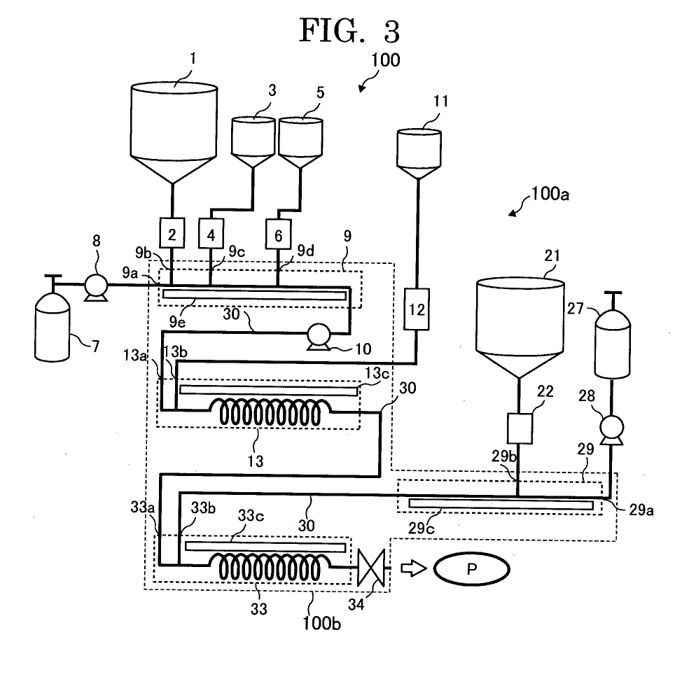

FIG. 3 is a system diagram illustrating one example of a method for producing a polylactic acid composition of the present invention. In the system diagram of FIG. 3, the polymerization reactor 100 includes: a supply unit 100a for supplying a compressive fluid and raw materials such as a ring-opening polymerizable monomer, nucleating agent, and crystallization promoter; and a main body of the polymerization reactor 100b for allowing the ring-opening polymerizable monomer supplied by the supply unit 100a to polymerize.

The supply unit 100a includes tanks (1, 3, 5, 7, 11, 21, 27), metering feeders (2, 4, 22), and metering pumps (6, 8, 12, 28). The main body of polymerization reactor 100b includes a contact section 9 provided at one end of the main body of polymerization reactor 100b, a liquid transfer pump 10, a reaction section 13, a contact section 29, a reaction section 33, and a pressure adjustment valve 34 provided at the tip of the reaction section 33.

The tank 1 of the supply unit 100a stores the ring-opening polymerizable monomer. The ring-opening polymerizable monomer to be stored may be a powder, or in the melted state. The tank 3 stores solid (powdery or granular) materials among the polymerization initiator and additives. The tank 5 stores liquid materials among the polymerization initiator and additives. The tank 7 stores the compressive fluid. The tank 21 stores the crystallization promoter.

Note that, the tank 7 may store a gas or solid that becomes a compressive fluid by application of heat or pressure during the process of supplying to the contact section 9, or in the contact section 9. In this case, the gas or solid stored in the tank 7 may be formed in the state of (1), (2), or (3) depicted in the phase diagram of FIG. 2, within the contact section 9 upon application of heat or pressure.

The metering feeder 2 measures the ring-opening polymerizable monomer stored in the tank 1 and continuously supplies the measured ring-opening polymerizable monomer to the contact section 9. The metering feeder 4 measures the solid materials stored in the tank 3 and continuously supplies the measured solid materials to the contact section 9. The metering pump 6 measures the liquid materials stored in the tank 5 and continuously supplies the measured liquid materials to the contact section 9. The metering pump 8 continuously supplies the compressive fluid stored in the tank 7 at the constant pressure and flow rate into the contact section 9. The metering feeder 22 measures the crystallization promoter stored in the tank 21 and continuously supplies the measured crystallization promoter to the contact section 33. The metering pump 28 continuously supplies the compressive fluid stored in the tank 27 at the constant pressure and flow rate into the contact section 33. Note that, in the case where the crystallization promoter is stored in the tank 21, the metering pump 28 and the tank 27 are not used.

In the present embodiment, “continuously supply” is a concept in contrast to a method for supplying per batch, and means supplying a respective material in the manner that a polylactic acid composition polymerized by ring-opening polymerization is continuously obtained. Namely, each material can be supplied intermittently, as long as a polylactic acid composition polymerized by ring-opening polymerization can be continuously obtained. In the case where the polymerization initiator and additives are all solids, the polymerization reactor 100 may not include the tank 5 and metering pump 6. Similarly, in the case where the polymerization initiator and additives are all liquids, the polymerization reactor 100 may not include the tank 3 and metering feeder 4.

In the present embodiment, the main body of polymerization reactor 100b includes a contact section 9 provided at one end of the main body of polymerization reactor 100b, a liquid transfer pump 10, a reaction section 13, a contact section 29, a reaction section 33, and a pressure adjustment valve 34 provided at the tip of the reaction section 33.

The reaction section 13 in the main body of polymerization reactor 100b is a tubular device having a monomer inlet for introducing a ring-opening polymerizable monomer, which is disposed at one end of the reaction section 13, and having a polymer outlet for discharging a polylactic acid composition obtained through polymerization of the ring-opening polymerizable monomer, which is disposed at the other end of the reaction section. Moreover, at the one end of the reaction section 13, a compressive fluid inlet for introducing a compressive fluid is further provided, and a catalyst inlet for introducing a catalyst is provided between the one end and the other end of the reaction section.

The reaction section 33 in the main body of polymerization reactor 100b is a tubular device having an inlet for introducing a polymer which is an intermediate product obtained through polymerization of the ring-opening polymerizable monomer, which is disposed at one end of the reaction section 33, and having a polymer outlet for discharging the resultant polylactic acid composition, which is disposed at the other end of the reaction section. Moreover, at the one end of the reaction section 33, an inlet for introducing a crystallization promoter is further provided.

Devices of the main body of polymerization reactor 100b are each connected through a pressure resistant pipe 30 for transporting the raw materials, compressive fluid, or ring-opening polymer obtained as an intermediate product, as illustrated in FIG. 3. Moreover, each device of the contact section 9, liquid transfer pump 10, reaction section 13, contact section 29, and reaction section 33 of the polymerization reactor includes a tubular member for passing the raw materials through.

The contact section 9 of the main body of polymerization reactor 100b is composed of a pressure resistant device or tube configured to continuously bring the raw materials (e.g. the ring-opening polymerizable monomer, nucleating agent, polymerization initiator, and additives) supplied from the tanks (1, 3, 5) into contact with the compressive fluid supplied from the tank 7.

In the contact section 9, the raw materials are melted or dissolved by bringing the raw materials into contact with a compressive fluid. In the present embodiment, the term “melt” means that raw materials or the resultant polylactic acid composition is plasticized or liquidized with swelling as a result of the contact between the raw materials or the resultant polylactic acid composition, and the compressive fluid.

Moreover, the term “dissolve” means that the raw materials are dissolved in the compressive fluid. When the ring-opening polymerizable monomer is dissolved, a fluid phase is formed. When the ring-opening polymerizable monomer is melted, a molten phase is formed. It is, however, preferred that a molten phase or fluid phase be formed with one phase in order to uniformly carry out a reaction. Moreover, it is preferred that the ring-opening polymerizable monomer be melted in order to carry out a reaction with a high ratio of the raw materials relative to the compressive fluid.

In the present embodiment, the raw materials (e.g., a ring-opening polymerizable monomer and nucleating agent), and a compressive fluid can be continuously brought into contact with each other at a constant concentration rate in the contact section 9 by continuously supplying the raw materials and the compressive fluid. As a result, the raw materials can be efficiently melted or dissolved.

The contact section 9 may be composed of a tank-shape device, or a tubular device, but it is preferably the tubular device from one end of which the raw materials are supplied and from the other end of which a mixture, such as a molten phase or a fluid phase, is taken out.

Further, the contact section 9 may include a stirring device for stirring the raw materials, and compressive fluid. The stirring device is not particularly limited and may be appropriately selected depending on the intended purpose. Examples thereof include a biaxial mixer having a single screw, a twin-screw engaging with each other, or a plurality of stirring elements which are engaged or overlapped with each other; a kneader including spiral stirring elements which are engaged with each other; or a static mixer. Among them, a biaxial or multi-axial stirring device engaging with each other is preferable because there is generated a less amount of depositions of a reaction product onto the stirring device or a container, and it has self-cleaning properties.

In the case where the contact section 9 does not include a stirring device, the contact section 9 is composed of a part of a pressure resistant pipe 30. Note that, in the case of the contact section 9 composed of the pipe 30, the ring-opening polymerizable monomer supplied to the contact section 9 is preferably turned into the liquid state in advance to surely mix all the materials in the contact section 9.

The contact section 9 is provided with an inlet 9a, as one example of a compressive fluid inlet, for introducing a compressive fluid supplied from the tank 7 by the metering pump 8; an inlet 9b, as one example of a monomer inlet, for introducing the ring-opening polymerizable monomer supplied from the tank 1 by the metering feeder 2, an inlet 9c for introducing the powder supplied from the tank 3 by the metering feeder 4; and an inlet 9d for introducing the liquid supplied from the tank 5 by the metering pump 6.

In the present embodiment, each inlet (9a, 9b, 9c, 9d) is composed of a connector for connecting a tubular member such as a cylinder or a part of a pipe 30 for supplying the raw materials in the contact section 9 with each pipe for transporting each of the raw materials or compressive fluid.

The connector is not particularly limited and may be appropriately selected depending on the intended purpose. Examples thereof include reducers, couplings, Y, T, and outlets. The contact section 9, moreover, includes a heater 9e for heating each of the supplied raw materials and compressive fluid.

The liquid transfer pump 10 send a mixture, such as a molten phase or a fluid phase formed in the contact section 9, to the reaction section 13. The tank 11 stores a catalyst. The metering pump 12 measures the catalyst stored in the tank 11 and supply the measured catalyst to the reaction section 13.

The reaction section 13 is composed of a pressure resistant device or tube for mixing the melted raw materials sent by the liquid transfer pump 10, with the catalyst supplied by the metering pump 12, to thereby carry out ring-opening polymerization of the ring-opening polymerizable monomer.

The reaction section 13 may be composed of a tank-shaped device or a tubular device, but it is preferably a tubular device as it gives a less dead space. Further, the reaction section 13 may include a stirring device for stirring the raw materials, and compressive fluid. The stirring device of the reaction section 13 is preferably a bi- or multi-axial stirring device having screws engaging with each other, stirring elements of 2-flights (ellipse), stirring elements of 3-flights (triangle), or circular or multi-leaf shape (clover shape) stirring wings, in view of self-cleaning. In the case where raw materials containing the catalyst are sufficiently mixed in advance, a motionless mixer, which divides and compounds (recombines) the flow in multiple stages by a guide device, can also be used as a stirring device.

The motionless mixer is not particularly limited and may be appropriately selected depending on the intended purpose. Examples thereof include multiflux batch mixers disclosed in Japanese examined patent application publication (JP-B) Nos. 47-15526, 47-15527, 47-15528, and 47-15533; a Kenics-type mixer disclosed in JP-A No. 47-33166; and motionless mixers similar to those listed without a moving part.

In the case where the reaction section 13 is not equipped with a stirring device, the reaction section 13 is composed of a part of a pressure resistant pipe 30. In this case, a shape of the pipe is not particularly limited and may be appropriately selected depending on the intended purpose, but it is preferably a spiral shape in view of downsizing of a device.

The reaction section 13 is provided with an inlet 13a for introducing the raw materials dissolved or melted in the contact section 9, and an inlet 13b, as one example of a catalyst inlet, for introducing the catalyst supplied from the tank 11 by the metering pump 12. In the present embodiment, each inlet (13a, 13b) is composed of a connector for connecting a tubular member, such as a cylinder or a part of pipe 30 for passing therein the raw materials through to the reaction section 13, with each pipe for supplying each of the raw materials or compressive fluid.

The connector is not particularly limited and may be appropriately selected depending on the intended purpose. Examples thereof include reducers, couplings, Y, T, and outlets. Note that, the reaction section 13 may be provided with a gas outlet for releasing evaporated materials. Moreover, the reaction section 13 includes a heater 13c for heating the transported raw materials.

The contact section 29 of the main body of polymerization reactor 100b is composed of a pressure resistant device or tube for turning a crystallization promoter supplied from the tank 21 into slurry.

The contact section 29 may be a biaxial stirring device having screws which are engaged with each other (inside diameter of cylinder: 30 mm, biaxial rotation with identical directions, rotational speed: 30 rpm).

The reaction section 33 of the main body of polymerization reactor 100b is composed of a pressure resistant device or tube for mixing a ring-opening polymer transported by the liquid transfer pump 10 with a crystallization promoter supplied from the metering feeder 22, following by allowing to crystallize.

The reaction section 33 may be a biaxial kneader (inside diameter of cylinder: 40 mm, biaxial rotation with identical directions, rotational speed: 60 rpm).

The resultant polylactic acid composition P can be continuously supplied from the pressure adjustment valve 34 provided at the tip of the reaction section 33 by utilizing a difference between internal pressure and external pressure of the reaction section 33.

FIG. 3 illustrates an embodiment where one reaction section 13 is used, but the polymerization reaction device 100 may include two or more reaction sections 13. In the case where a plurality of reaction sections 13 are included, the reaction (polymerization) conditions per reaction section 13 (e.g., the temperature, concentration of the catalyst, the pressure, the average retention time, and stirring speed) can be the same as in the case only one reaction section is used, but they are preferably optimized per reaction section corresponding to the progress of the polymerization. Note that, it is not very good idea that excessively large number of reaction sections 13 is connected to give many stages, as it may extend a reaction time, or a device may become complicated. The number of stages is preferably 1 to 4, more preferably 1 to 3.

In the case where polymerization is performed with only one reaction section, a polymerization degree of the resultant polylactic acid composition and an amount of ring-opening polymerizable monomer residues are generally unstable, and tend to be varied, and therefore it is not suitable in industrial productions. It is thought that the instability thereof is caused because raw materials having the melt viscosity of a few poises to several tens poises and the polymerized polylactic acid composition having the melt viscosity of several thousands poises are present together. In the present embodiment, compared to the above, the viscosity difference in the reaction section 13 (may be referred to as a “polymerization system”) can be reduced, as the raw materials and the resultant polylactic acid composition product are melted (liquidized). Therefore, a polylactic acid composition can be stably produced even when the number of stages is reduced compared to that in the conventional polymerization reactor.

Subsequently, a method for polymerizing a ring-opening polymerizable monomer using a polymerization reactor 100 illustrated in FIG. 3 will be explained.

In the present embodiment, a ring-opening polymerizable monomer and compressive fluid are continuously supplied and brought into contact with each other, and are allowed to carry out ring-opening polymerization of the ring-opening polymerization monomer, to thereby continuously produce a ring-opening polymer (polylactic acid) (polymerization step).

Then, the ring-opening polymer obtained in the polymerization step is mixed with a crystallization promotor (crystallization step).

First, each of the metering feeders (2, 4) and the metering pumps (6, 8) are operated to continuously supply a ring-opening polymerizable monomer, nucleating agent, polymerization initiator, additives, and compressive fluid in the tanks (1, 3, 5, 7). As a result, the raw materials and compressive fluid are continuously introduced into the tube of the contact section 9 from respective inlets (9a, 9b, 9c, 9d). Note that, the weight accuracy of solid (powder or granular) raw materials may be low compared to that of the liquid raw materials. In this case, the solid raw materials may be melted into a liquid to be stored in the tank 5, and then introduced into the tube of the contact section 9 by the metering pump 6. The order for operating the metering feeders (2, 4) and the metering pumps (6, 8) are not particularly limited and may be appropriately selected depending on the intended purpose, but it is preferred that the metering pump 8 be operated first because there is a possibility that raw materials are solidified due to a decrease in temperature when the initial raw materials are sent to the reaction section 13 without being in contact with the compressive fluid.

The speed for feeding each of the raw materials by the respective metering feeder (2, 4) or metering pump 6 is adjusted based on the predetermined mass ratio of the ring-opening polymerizable monomer, nucleating agent, polymerization initiator, and additives so that the mass ratio is kept constant. A total mass of each of the raw material supplied per unit time by the metering feeders (2, 4) or metering pump 6 (the feeding speed of the raw materials (g/min)) is adjusted based on desirable physical properties of a polymer or a reaction time. Similarly, a mass of the compressive fluid supplied per unit time by the metering pump 8 (the feeding speed of the compressive fluid (g/min)) is adjusted based on desirable physical properties of a polymer or a reaction time. A ratio of the feeding speed of the raw material to the feeding speed of the compressive fluid (feeding speed of raw materials/feeding speed of compressive fluid, may be referred to as a feeding ratio) is not particularly limited and may be appropriately selected depending on the intended purpose, but is preferably 1 or more, more preferably 3 or more, further preferably 5 or more, and particularly preferably 10 or more. The upper limit of the feeding ratio is preferably 1,000 or lower, more preferably 100 or lower, particularly preferably 50 or lower.

By setting the feeding ratio to 1 or greater, a reaction progresses with the high concentration of the raw materials and the resultant polylactic acid composition (i.e., high solid content) when the raw materials and the compressive fluid are sent to the reaction section 13. The solid content in the polymerization system here is largely different from a solid content in a polymerization system where polymerization is performed by dissolving a small amount of a ring-opening polymerizable monomer in a significantly large amount of a compressive fluid in accordance with a conventional production method of a polylactic acid composition. The method for producing a polylactic acid composition of the present invention is characterized by that a polymerization reaction progresses efficiently and stably in a polymerization system having a high solid content. Note that, in the present embodiment, the feeding ratio may be set to less than 1. In this case, quality of the resultant polylactic acid composition has no problem, but economical efficiency is not satisfactory. When the feeding ratio is greater than 1,000, there is a possibility that the compressive fluid may not sufficiently dissolve the ring-opening polymerizable monomer therein, and the intended reaction does not uniformly progress.

Since the raw materials and the compressive fluid are each continuously introduced into the tube of the contact section 9, they are continuously brought into contact with each other. As a result, each of the raw materials, such as the ring-opening polymerizable monomer, the nucleating agent, the polymerization initiator, and the additives, is dissolved or melted in the contact section 9. In the case where the contact section 9 includes a stirring device, the raw materials and compressive fluid may be stirred. In order to prevent the introduced compressive fluid from turning into gas, the internal temperature and pressure of the tube of the reaction section 13 are controlled to the temperature and pressure both equal to or higher than a triple point of the compressive fluid. The control of the temperature and pressure here is performed by adjusting the output of the heater 9e of the contact section 9, or adjusting the feeding amount of the compressive fluid. In the present embodiment, the temperature for melting the ring-opening polymerizable monomer may be the temperature equal to or lower than the melting point of the ring-opening polymerizable monomer under atmospheric pressure. It is assumed that the internal pressure of the contact section 9 becomes high under the influence of the compressive fluid, so that the melting point of the ring-opening polymerizable monomer becomes lower than the melting point thereof under the atmospheric pressure. Accordingly, the ring-opening polymerizable monomer is melted in the contact section 9, even when an amount of the compressive fluid is small with respect to the ring-opening polymerizable monomer.

In order to melt each of the raw materials efficiently, the timing for applying heat to or stirring the raw materials and compressive fluid in the contact section 9 may be adjusted. In this case, heating or stirring may be performed after bringing the raw materials and compressive fluid into contact with each other, or heating or stirring may be performed while bringing the raw materials and compressive fluid into contact with each other. To ensure melting of the materials, for example, the ring-opening polymerizable monomer and the compressive fluid may be brought into contact with each other after heating the ring-opening polymerizable monomer at the temperature equal to or higher than the melting point thereof. In the case where the contact section 9 is a biaxial mixing device, for example, each of the aforementioned aspects may be realized by appropriately setting an alignment of screws, arrangement of inlets (9a, 9b, 9c, 9d), and temperature of the heater 9e.

In the present embodiment, the additives are supplied to the contact section 9 separately from the ring-opening polymerizable monomer, but the additives may be supplied together with ring-opening polymerizable monomer. Alternatively, the additives may be supplied after completion of a polymerization reaction. In this case, after taking the resultant polylactic acid out from the reaction section 13, the additive may be added to the resultant polylactic acid while kneading the mixture of the additives and the resultant polylactic acid.

The raw materials dissolved or melted in the contact section 9 are each sent by the liquid transfer pump 10, and supplied to the reaction section 13 through the inlet 13a. Meanwhile, the catalyst in the tank 11 is measured by the metering pump 12, a predetermined amount of which is supplied to the reaction section 13 through the inlet 13b. The catalyst can function even at room temperature, and therefore, in the present embodiment, the catalyst is added after melting the raw materials in the compressive fluid. In the conventional art, the timing for adding the catalyst has not been discussed in association with the ring-opening polymerization of the ring-opening polymerizable monomer using the compressive fluid. In the present embodiment, in the course of the ring-opening polymerization, the catalyst is added to the polymerization system in the reaction section 13 because of the high activity of the catalyst, where the polymerization system contains a mixture of raw materials such as the ring-opening polymerizable monomer, the nucleating agent, and the polymerization initiator, sufficiently dissolved or melted in the compressive fluid. When the catalyst is added in the state where the mixture is not sufficiently dissolved or melted, a reaction may unevenly progress.

The raw materials each sent by the liquid transfer pump 10 and the catalyst supplied by the metering pump 12 are sufficiently stirred by a stirring device of the reaction section 13, or heated by a heater 13c to the predetermined temperature when transferred, if necessary. As a result, ring-opening polymerization reaction of the ring-opening polymerizable monomer is carried out in the reaction section 13 in the presence of the catalyst (polymerization step).

The lower limit of the temperature for ring-opening polymerization of the ring-opening polymerizable monomer (polymerization reaction temperature) is not particularly limited and may be appropriately selected depending on the intended purpose, but it is preferably 40° C. or higher, more preferably 50° C. or higher, and further preferably 60° C. or higher. When the polymerization reaction temperature is lower than 40° C., it may take a long time to melt the ring-opening polymerizable monomer in the compressive fluid, depending on the type of the ring-opening polymerizable monomer, or melting of the ring-opening polymerizable monomer may be insufficient, or the activity of the catalyst may be low. As a result, the reaction speed may be easily reduced during the polymerization, and therefore the polymerization reaction may not progress quantitatively.

The upper limit of the polymerization reaction temperature is not particularly limited and may be appropriately selected depending on the intended purpose, but it is preferably either 150° C. or lower, or a temperature that is higher than the melting point of the ring-opening polymerizable monomer by 50° C., whichever higher. The upper limit of the polymerization reaction temperature is more preferably 100° C. or lower, or a temperature that is higher than the melting point of the ring-opening polymerizable monomer by 30° C., whichever higher. The upper limit of the polymerization reaction temperature is further preferably 90° C. or lower, or the melting point of the ring-opening polymerizable monomer, whichever higher. The upper limit of the polymerization reaction temperature is particularly preferably 80° C. or lower, or temperature that is lower than the melting point of the ring-opening polymerizable monomer by 20° C., whichever higher.

When the polymerization reaction temperature is higher than the temperature that is higher than the melting point of the ring-opening polymerizable monomer by 30° C., a depolymerization reaction, which is a reverse reaction of ring-opening polymerization, tends to be caused equilibrately, and therefore the polymerization reaction is difficult to proceed quantitatively. In the case of using a ring-opening monomer having low melting point, such as a ring opening polymerizable monomer that is liquid at room temperature, the polymerization reaction temperature may be a temperature which is higher than the melting point by 30° C. to enhance the activity of the catalyst. In this case, however, the polymerization reaction temperature is preferably 100° C. or lower. Note that, the polymerization reaction temperature is controlled by a heater 13c equipped with the reaction section 13, or by externally heating the reaction section 13. When the polymerization reaction temperature is measured, a polylactic acid composition obtained by the polymerization reaction may be used for the measurement.

In a conventional production method of a polylactic acid composition using supercritical carbon dioxide, polymerization of a ring-opening polymerizable monomer has been carried out using a large amount of supercritical carbon dioxide as supercritical carbon dioxide has low ability of dissolving a polylactic acid composition. In accordance with the polymerization method of the present embodiment, ring-opening polymerization of a ring-opening polymerizable monomer is performed with a high concentration, which has not been realized in a conventional art, in the course of production of a polylactic acid composition using a compressive fluid. In this case, the internal pressure of the reaction section 13 becomes high in the presence of the compressive fluid, and thus glass transition temperature (Tg) of the resultant polylactic acid composition becomes low. As a result, the resultant polylactic acid composition has low viscosity, and therefore a ring-opening reaction uniformly progresses even in the state where the concentration of the polylactic acid composition is high.

The polymerization reaction time (the average retention time in the reaction section 13) is not particularly limited and is appropriately set depending on a target molecular weight of a polylactic acid composition to be produced. Generally, the polymerization reaction time is preferably within 1 hour, more preferably within 45 minutes, and further preferably within 30 minutes. The production method of the present embodiment can reduce the polymerization reaction time to 20 minutes or shorter. This polymerization reaction time is short, which has not been realized before in polymerization of a ring-opening polymerizable monomer in a compressive fluid.

The pressure for the polymerization, i.e., the pressure of the compressive fluid, may be the pressure at which the compressive fluid supplied by the tank 7 becomes a liquid gas ((2) in the phase diagram of FIG. 2), or high pressure gas ((3) in the phase diagram of FIG. 2), but it is preferably the pressure at which the compressive fluid becomes a supercritical fluid ((1) in the phase diagram of FIG. 2). By making the compressive fluid into the state of a supercritical fluid, melting of the ring-opening polymerizable monomer may be accelerated to thereby allow a polymerization reaction to progress uniformly and quantitatively. In the case where carbon dioxide is used as the compressive fluid, the pressure is not particularly limited and may be appropriately selected depending on the intended purpose, but is preferably 3.7 MPa or higher, more preferably 5 MPa or higher, particularly preferably 7.4 MPa or higher, which is the critical pressure or higher, in view of efficiency of a reaction and polymerization rate. In the case where carbon dioxide is used as the compressive fluid, moreover, the temperature thereof is preferably 25° C. or higher from the same reasons to the above.

The moisture content in the reaction section 13 is not particularly limited and may be appropriately selected depending on the intended purpose, but is preferably 4 mol % or less, more preferably 1 mol % or less, and further preferably 0.5 mol % or less, relative to 100 mol % of the ring-opening polymerizable monomer. When the moisture content is greater than 4 mol %, it may be difficult to control a molecular weight of a resultant product as the moisture itself acts as a polymerization initiator. In order to control the moisture content in the polymerization system, an operation for removing moistures contained in the ring-opening polymerizable monomer and other raw materials may be optionally provided as a pretreatment.

Next, the metering feeder 22 is operated to continuously and quantitatively supply a crystallization promoter in the tank 21 to a biaxial stirring device of the contact section 29 at the feeding speed of 0.22 g/min.

A polymer (polylactic acid) which is an intermediate product in the melted state obtained through polymerization in the reaction section 13 and the crystallization promoter were continuously supplied to a biaxial kneader in the reaction section 33. Thus, the polymer was continuously mixed with the crystallization promoter in the reaction section 33 (mixing step).

Note that, the internal pressure of each of the contact section 9, the contact section 29, the reaction section 13, and the reaction section 33 is set to 15 MPa by adjusting the opening and closing degree of the pressure adjustment valve 34. The temperatures of the transfer paths of the biaxial stirring devices of the contact sections (9, 29) are each 150° C. at the inlet, and 150° C. at the outlet. The temperatures of the transport paths of the biaxial kneaders of the reaction sections (13, 33) are each 150° C. at both the inlet and the outlet. Moreover, the average retention time of each raw material in the contact section 9, the contact section 29, the reaction section 13, and the reaction section 33 is set to 1,200 seconds by adjusting the length or the piping system of each of the contact section 9, the contact section 29, the reaction section 13, and the reaction section 33.

The pressure adjustment valve 34 is provided at the tip of the reaction section 33, and the resultant polylactic acid composition P can be continuously discharged from the pressure adjustment valve 34. Thus, uniform polylactic acid composition can be obtained.

The catalyst remained in the resultant polylactic acid composition is removed, if necessary.

A method for removing the catalyst is not particularly limited and may be appropriately selected depending on the intended purpose. Examples thereof include vacuum distillation in case of a compound having a boiling point; a method for extracting and removing the catalyst using a compound dissolving the catalyst as an entrainer; and a method for absorbing the catalyst with a column to remove the catalyst. A method for removing the catalyst may be a batch manner where the resultant polylactic acid composition is taken out from the reaction section 33 and then the catalyst is removed therefrom, or a continuous manner where the catalyst is continuously removed in the reaction section without taking the resultant polylactic acid composition out of the reaction section. In the case of vacuum distillation, the vacuum condition is set based on a boiling point of the catalyst. For example, the temperature in the vacuum is 100° C. to 120° C., and the catalyst can be removed at the temperature lower than the temperature at which the resultant polylactic acid composition is depolymerized. When an organic solvent is used in the process of extraction, it may be necessary to provide a step for removing the organic solvent after extracting the catalyst. Therefore, it is preferred that a compressive fluid be used as a solvent for the extraction. As for the process of such extraction, conventional techniques used for extracting perfumes may be diverted.

In a method for producing a polylactic acid composition of the present invention, the polymerization rate of a ring-opening polymerizable monomer is not particularly limited and may be appropriately selected depending on the intended purpose, but is preferably 98 mol % or higher. When the polymerization rate is lower than 98 mol %, the polymer product does not have satisfactory thermal characteristics to function as a polylactic acid composition, and therefore it may be necessary to separately provide an operation for removing a ring-opening polymerizable monomer.

Note that, the polymerization rate can be obtained by deducting an amount of the unreacted ring-opening polymerizable monomer from an amount of the ring-opening polymerizable monomer added, and means a ratio of the ring opening polymerizable monomer contributed to generation of a polylactic acid composition.

The polymerization rate of polylactic acid can be determined as follows. Specifically, an amount of the unreacted ring-opening polymerizable monomer (mol %) was determined by calculating a ratio of a quartet peak area attributed to lactide (4.98 ppm to 5.05 ppm) to a quartet peak area attributed to polylactic acid (5.10 ppm to 5.20 ppm) in deuterated chloroform by means of a nuclear magnetic resonance apparatus (JNM-AL300, product of JEOL Ltd.), and by multiplying the obtained ratio with 100. The polymerization rate can be determined by deducting the amount of the unreacted ring-opening polymerizable monomer (mol %) from 100 mol %.

In a conventional melt polymerization method of a ring-opening polymerizable monomer, unreacted monomers remain in the resultant polylactic acid composition because the ring-opening polymerizable monomers are allowed to react at high temperature of 150° C. or higher. Therefore, it may be necessary to provide a step for removing the unreacted ring-opening polymerizable monomers. In the case of a solution polymerization using a solvent, it is necessary to provide a step for removing an organic solvent in order to use the resultant polylactic acid composition in the solid state. Namely, in both of the above conventional methods, production cost must be increased due to an increase of the number of steps and a decrease in yield.

In accordance with a method for producing a polylactic acid composition of the present invention, a ring-opening polymerizable monomer, a compressible fluid, and a nucleating agent are mixed with each other, followed by allowing the ring-opening polymerizable monomer to ring-opening polymerize in the presence of a catalyst, to thereby obtain a ring-opening polymer. Then, the resultant ring-opening polymer is mixed with a crystallization promoter. In this case, it is possible to provide a polylactic acid composition having excellent mold formability and thermal stability at low cost, with low environmental load, energy saving, and resource saving, because of the following reasons.

(1) A reaction proceeds at low temperature compared to a melt polymerization method.
(2) As the reaction proceeds at low temperature, a side reaction hardly occurs, and thus a polylactic acid composition can be obtained at high yield relative to an amount of the ring-opening polymerizable monomer added (namely, an amount of unreacted ring-opening polymerizable monomer is small). Accordingly, a purification step for removing unreacted ring-opening polymerizable monomer, which is performed for attaining a polylactic acid composition having excellent mold formability and thermal stability, can be simplified, or omitted.
(3) A drying step is simplified or omitted, because a waste liquid is not generated, and a dry polylactic acid composition can be obtained with one stage.
(4) As the compressive fluid is used, a ring-opening polymerization reaction can be performed without an organic solvent. Note that, the organic solvent means a liquid organic compound used for dissolving the ring-opening polymerizable monomer.
(5) A uniform proceeding of a polymerization can be achieved because ring-opening polymerization is carried out by adding an organic catalyst after dissolving the ring-opening polymerizable monomer in the compressive fluid. Accordingly, a method of the present invention can be suitably used when optical isomers or copolymers with other monomers are produced.
(6) As organic catalyst can be removed in addition to continuous polymerization of a polylactic acid composition, a polylactic acid composition containing an extremely small amount of organic catalyst residues can be obtained.

### EXAMPLES

The present invention will be more specifically described with reference to Examples and Comparative Examples, but Examples shall not be construed as to limit the scope of the present invention in any way.

### Example 1

Ring-opening polymerization of L-lactide was performed by means of the polymerization reactor 100 of FIG. 3. The configuration of the polymerization reactor 100 was as follows.

(1) Tank 1 and Metering Feeder 2 (Plunger pump NP-S462, product of Nihon Seimitsu Kagaku Co., Ltd.):

The tank 1 was charged with a mixture of L-lactide serving as a ring-opening polymerizable monomer (product of Purac, melting point: 100° C.) and ethylene glycol serving as a polymerization initiator (molar ratio 99:1). Note that, the lactide was allowed to be turned into the liquid state by heating it to the temperature equal to or higher than the melting point thereof in the tank 1. To 100 parts by mass of the lactide, was added 10 parts by mass of talc (SG-95, product of NIPPON TALC Co., Ltd.) serving as a nucleating agent.

(2) Tank 3 and Metering Feeder 4: Not used in this Example.
(3) Tank 5 and Metering Pump 6: Not used in this Example.
(4) Tank 7: Carbonic acid gas cylinder was used.
(5) Tank 27: Not used in this Example.
(6) Tank 21 and Metering Feeder 22 (Plunger pump NP-S462, product of Nihon Seimitsu Kagaku Co., Ltd.):

Tank 21 was charged with polyglycerol fatty acid ester (CHIRABAZOL VR-05, product of Taiyo Kagaku Co., Ltd.) serving as a crystallization promoter. Note that, the polyglycerol fatty acid ester in the paste form was allowed to be turned into the liquid state by heating it to 100° C. in the tank 21.

(7) Tank 11 and Metering Pump 12 (INTELLIGENT HPLC pump PU-2080, product of JASCO Corporation):

Tank 11 was charged with tin di(2-ethylhexanoate) serving as a catalyst.

(8) Contact section 9: Biaxial stirring device equipped with screws engaged with each other (inside diameter of cylinder: 30 mm, biaxial rotation with identical directions, rotational speed: 30 rpm) was used.
(9) Contact section 29: Biaxial stirring device equipped with screws engaged with each other (inside diameter of cylinder: 30 mm, biaxial rotation with identical directions, rotational speed: 30 rpm) was used.
(10) Reaction section 13: biaxial kneader (TME-18, product of TOSHIBA CORPORATION) (inside diameter of cylinder: 40 mm, biaxial rotation with identical directions, rotational speed: 60 rpm) was used.
(11) Reaction section 33: biaxial kneader (TME-18, product of TOSHIBA CORPORATION) (inside diameter of cylinder: 40 mm, biaxial rotation with identical directions, rotational speed: 60 rpm) was used.

Next, the metering feeder 2 was operated to constantly supply raw materials (lactide, ethylene glycol, and talc) in the tank 1 to the biaxial stirring device of the contact section 9 at the feeding speed of 4 g/min. The metering pump 8 was operated to continuously supply carbonic acid gas in the tank 7 to the biaxial stirring device of the contact section 9 so that the amount of the carbonic acid gas was 5 parts by mass relative to 100 parts by mass of the supplied amount of the raw materials. In the manner as mentioned, the raw materials containing lactide, ethylene glycol, and talc were continuously brought into contact with the compressive fluid and the raw materials were melted in the biaxial stirring device of the contact section 9.

The raw materials melted in the contact section 9 were sent to the biaxial kneader of the reaction section 13 by means of the liquid transfer pump 10. Meanwhile, the metering pump 12 was operated to supply tin di(2-ethylhexanoate) serving as a polymerization catalyst stored in the tank 11 to the reaction section 13 so that the molar ratio of tin di(2-ethylhexanoate) to lactide serving as the ring-opening polymerizable monomer was 99:1. In the manner as mentioned, lactide was continuously allowed to ring-opening polymerize in the reaction section 13 in the presence of tin di(2-ethylhexanoate) (polymerization step). Thus, a ring-opening polymer (polylactic acid) was continuously produced as an intermediate product in the reaction section 13.

The metering feeder 22 was operated to continuously and quantitatively supply polyglycerol fatty acid ester serving as the crystallization promoter stored in the tank 21 to the biaxial stirring device of the contact section 29 at the feeding speed of 0.22 g/min. The polyglycerol fatty acid ester serving as the crystallization promoter was added so that the amount of the polyglycerol fatty acid ester was 5 parts by mass relative to 100 parts by mass of the supplied amount of ring-opening polymer (polylactic acid).

The ring-opening polymer (polylactic acid), as the intermediate product in the melted state polymerized in reaction section 13, and the polyglycerol fatty acid ester as the crystallization promoter were both continuously supplied into the biaxial kneader of the reaction section 33. In the manner as mentioned, the ring-opening polymer (polylactic acid) as the intermediate product was continuously mixed with the polyglycerol fatty acid c ester as the crystallization promoter in the reaction section 33 (mixing step).

Note that, in Example 1, the internal pressure of each of the contact section 9, the contact section 29, the reaction section 13, and the reaction section 33 was set to 15 MPa by adjusting the opening and closing degree of the pressure adjustment valve 34. The temperatures of the transfer paths of the biaxial stirring devices of the contact sections (9, 29) were each 150° C. at the inlet, and 150° C. at the outlet. The temperatures of the transport paths of the biaxial kneaders of the reaction sections (13, 33) were each 150° C. at both the inlet and the outlet. Moreover, the average retention time of each raw material in the contact section 9, the contact section 29, the reaction section 13, and the reaction section 33 was set to 1,200 seconds by adjusting the length or the piping system of each of the contact section 9, the contact section 29, the reaction section 13, and the reaction section 33.

The pressure adjustment valve 34 was provided at the tip of the reaction section 33, and the resultant polylactic acid composition P was continuously discharged from the pressure adjustment valve 34.

The resultant polylactic acid composition was evaluated for the amount of ring-opening polymerizable monomer residue, the molecular weight, the molecular weight distribution, the Charpy impact strength, and the yellow index (YI value) as follows. Results are shown in Table 1.

### <Amount of Ring-Opening Polymerizable Monomer Residue>

An amount of the ring-opening polymerizable monomer residues contained in the resultant polylactic acid composition was determined in accordance with a method for measuring an amount of lactide described in “Voluntary Standard for Food Containers and Wrappings Formed of Synthetic Resin such as Polyolefin, the third revised edition, added in June, 2004, Part 3, Standard Methods of Analysis for Hygienic Chemists, p. 13”. Specifically, the polylactic acid composition was homogeneously dissolved in dichloromethane. To this solution, a mixed solution of acetone and cyclohexane was added, to thereby reprecipitate the polylactic acid composition. The supernatant liquid thus obtained was provided to gas chromatograph (GC) equipped with a flame ionization detector (FID), to separate ring-opening polymerizable monomer residues (lactide). The separated ring-opening polymerizable monomer residues were quantified by the internal reference method, to thereby determine an amount of the ring-opening polymerizable monomer residues contained in the polylactic acid composition. Note that, the measurement of GC can be performed under the following conditions. In each table, “ppm” means “ppm by mass.”

### <<GC Measurement Conditions>>

Column: Capillary column (DB-17MS, product of J & W Scientific, length: 30 m, internal diameter: 0.25 mm, film thickness: 0.25 μm)

Internal standard: 2,6-dimethyl-γ-pyrone

Flow rate of column: 1.8 mL/min

Temperature of column: Retained at 50° C. for 1 minute, heated at constant speed of 25° C./rain, and retained at 320° C. for 5 minutes.

Detector: Flame ionization detector (FID)

### <Measurement of Molecular Weight of Polylactic Acid Composition>

The molecular weight was measured through gel permeation chromatography (GPC) under the following conditions:

Apparatus: GPC-8020 (product of TOSOH CORPORATION)

Column: TSK G2000HXL and G4000HXL (product of TOSOH CORPORATION)

Temperature: 40° C.

Solvent: Tetrahydrofuran (THF)

Flow rate: 1.0 mL/min

First, a calibration curve of molecular weight was obtained using monodispersed polystyrene serving as a standard sample. A polylactic acid composition (1 mL) having a concentration of 0.5% by mass was applied and measured under the above conditions, to thereby obtain the molecular weight distribution of the polylactic acid composition. The number average molecular weight Mn and the weight average molecular weight Mw of the polylactic acid composition were calculated from the calibration curve. The molecular weight distribution is a value calculated by dividing Mw by Mn.

### <Yellowing Index (YI Value)>

A 2 mm-thick resin pellet was formed from the obtained polylactic acid composition, and the resultant pellet was measured by means of SM COLOR COMPUTER (product of Suga Test Instruments Co., Ltd.) in accordance with JIS-K7103 to thereby determine a YI value.

### <Charpy Impact Strength>

A 10 mm-thick notched specimen was formed from the obtained polylactic acid composition in accordance with ISO 179, and the resultant specimen was measured for the Charpy impact strength (kJ/m²) by means of UNIVERSAL IMPACT TESTER (60 kg-cm hammer, product of TOYO SEIKI Co., Ltd.).

### Examples 2 to 9 and Comparative Examples 1 to 5

Polylactic acid compositions of Examples 2 to 9 and Comparative Examples 1 to 5 were produced in the same manner as in Example 1, except that types and amounts of nucleating agents and crystallization promoters, and amounts of polymerization initiators were changed according to the following Tables 1 to 3.

The resultant polylactic acid compositions were evaluated for properties in the same manner as in Example 1. Results are shown in Tables 1 to 3.

### Example 10

The polylactic acid composition of Example 10 was produced in the same manner as in Example 1, except that a type of the catalyst was changed to DBU, a temperature of the transfer path of the biaxial stirring device was set to 80° C. at both the inlet and the outlet, a type of each of the nucleating agent and the crystallization promoter, and the amount of the polymerization initiator were changed according to the following Table 2.

The resultant polylactic acid composition of Example 10 was evaluated for properties in the same manner as in Example 1. Results are shown in Table 2.

TABLE 1

| | Ingredients | | | | | |
|---|---|---|---|---|---|---|
| | (parts by mass) | Ex. 1 | Ex. 2 | Ex. 3 | Ex. 4 | Ex. 5 |
| Type of | Lactide | 100 | 100 | 100 | 100 | 100 |
| monomer | | | | | | |
| Initiator | Ethylene glycol | 0.05 | 0.01 | 0.05 | 0.05 | 0.05 |
| Catalyst | Tin di(2-ethyl- | 0.05 | 0.05 | 0.05 | 0.05 | 0.05 |
| | hexanoate) | | | | | |
| | DBU | — | — | — | — | — |
| Nucleating | Talc | 10 | 10 | — | — | — |
| agent | Kaolinite | — | — | 10 | — | — |
| | Phosphoric acid | — | — | — | 1 | — |
| | ester metal salt | | | | | |
| | compound | | | | | |
| | Rosin acid metal | — | — | — | — | 1 |
| | salt compound | | | | | |
| Crystallization | Polyglycerol fatty | 5 | 5 | 5 | 5 | 5 |
| promoter | acid ester | | | | | |
| | PO-EO copolymer | — | — | — | — | — |
| Measurement | Weight average | 120,000 | 240,000 | 240,000 | 115,000 | 132,000 |
| of molecular | molecular weight | | | | | |
| weight | (Mw) | | | | | |
| | Molecular weight | 1.9 | 2.0 | 2.0 | 1.8 | 1.9 |
| | distribution | | | | | |
| | (Mw/Mn) | | | | | |

| | | | | | |
|---|---|---|---|---|---|
| Amount of monomer residues | 500 | 600 | 1,000 | 800 | 600 |
| (ppm by mass) | | | | | |
| Impact strength (kJ/m²) | 13 | 25 | 32 | 16 | 12 |
| YI value | 0.8 | 1.2 | 0.5 | 0.8 | 1.5 |

TABLE 2

| | Ingredients | | | | | |
|---|---|---|---|---|---|---|
| | (parts by mass) | Ex. 6 | Ex. 7 | Ex. 8 | Ex. 9 | Ex. 10 |
| Type of | Lactide | 100 | 100 | 100 | 100 | 100 |
| monomer | | | | | | |
| Initiator | Ethylene glycol | 0.05 | 0.05 | 0.05 | 0.05 | 0.05 |
| Catalyst | Tin di(2-ethyl- | 0.05 | 0.05 | 0.05 | 0.05 | — |
| | hexanoate) | | | | | |
| | DBU | — | — | — | — | 0.10 |
| Nucleating | Talc | 10 | — | — | — | 10 |
| agent | Kaolinite | — | 10 | — | — | — |
| | Phosphoric acid | — | — | 1 | — | — |
| | ester metal salt | | | | | |
| | compound | | | | | |
| | Rosin acid metal | — | — | — | 1 | — |
| | salt compound | | | | | |
| Crystallization | Polyglycerol fatty | — | — | — | — | — |
| promoter | acid ester | | | | | |
| | PO-EO copolymer | 5 | 5 | 5 | 5 | 5 |
| Measurement | Weight average | 125,000 | 128,000 | 118,000 | 126,000 | 108,000 |
| of molecular | molecular weight | | | | | |
| weight | (Mw) | | | | | |
| | Molecular weight | 2.0 | 2.0 | 1.9 | 1.8 | 2.0 |
| | distribution | | | | | |
| | (Mw/Mn) | | | | | |

| | | | | | |
|---|---|---|---|---|---|
| Amount of monomer residues | 200 | 500 | 800 | 2,400 | 800 |
| (ppm by mass) | | | | | |
| Impact strength (kJ/m²) | 17 | 16 | 13 | 15 | 18 |
| YI value | 1.2 | 0.6 | 1.8 | 1.1 | 3.2 |

TABLE 3

| | Ingredients | Comp. | Comp. | Comp. | Comp. | Comp. |
|---|---|---|---|---|---|---|
| | (parts by mass) | Ex. 1 | Ex. 2 | Ex. 3 | Ex. 4 | Ex. 5 |
| Type of | Lactide | 100 | 100 | 100 | 100 | 100 |
| monomer | | | | | | |
| Initiator | Ethylene glycol | 0.20 | 0.10 | 0.05 | 0.05 | 0.05 |
| Catalyst | Tin | 0.05 | 0.05 | 0.05 | 0.05 | 0.05 |
| | di(2-ethylhexanoate) | | | | | |
| | DBU | — | — | — | — | — |
| Nucleating | Talc | 10 | 10 | — | 10 | — |
| agent | Kaolinite | — | — | — | — | — |
| | Phosphoric acid ester | — | — | — | — | — |
| | metal salt compound | | | | | |
| | Rosin acid metal salt | — | — | — | — | — |
| | compound | | | | | |
| Crystallization | Polyglycerol fatty acid | 5 | 5 | — | — | 5 |
| promoter | ester | | | | | |
| | PO-EO copolymer | — | — | — | — | — |
| Measurement | Weight average | 48,000 | 98,000 | 134,000 | 124,000 | 118,000 |
| of molecular | molecular weight (Mw) | | | | | |
| weight | Molecular weight | 2.2 | 1.9 | 2.1 | 2.1 | 2.0 |
| | distribution (Mw/Mn) | | | | | |

| | | | | | |
|---|---|---|---|---|---|
| Amount of monomer residues | 800 | 12,000 | 12,000 | 12,000 | 12,000 |
| (ppm by mass) | | | | | |
| Impact strength (kJ/m²) | 4 | 12 | 3 | 7 | 8 |
| YI value | 2.4 | 8.0 | 1.2 | 2.5 | 1.4 |

Materials described in Tables 1 to 3 will be specifically described.
Talc: SG-95, product of NIPPON TALC Co., Ltd.
Kaolinite: SATINTONE No. 5, product of TAKEHARA KAGAKU KOGYO CO., LTD.
Phosphoric acid ester metal salt compound: ADEKASTAB NA-11, product of ADEKA CORPORATION
Rosin acid metal salt compound: PINECRYSTAL KR-50M, product of ARAKAWA CHEMICAL INDUSTRIES, LTD.
Polyglycerol fatty acid ester: CHIRABAZOL VR-05, product of Taiyo Kagaku Co., Ltd.
PO-EO copolymer (Polyethylene glycol-polypropylene glycol copolymer): PLURONIC F68, product of ADEKA CORPORATION

Embodiments of the present invention are as follows.

<1> A polylactic acid composition, containing:

polylactic acid,

wherein the polylactic acid composition contains a ring-opening polymerizable monomer residue in a concentration of 100 ppm by mass to 5,000 ppm by mass, and

wherein the polylactic acid composition has a weight average molecular weight of 100,000 or more but less than 300,000 as measured by gel permeation chromatography, a yellow index (YI) value of 5 or less, and a Charpy impact strength of 10 kJ/m² or more.

<2> The polylactic acid composition according to <1>, wherein the polylactic acid composition contains a nucleating agent, a crystallization promoter, or both thereof, and

wherein the nucleating agent is an organic crystal nucleating agent, an inorganic crystal nucleating agent, or both thereof.

<3> The polylactic acid composition according to <2>, wherein the organic crystal nucleating agent is at least one selected from a phosphoric acid ester metal salt compound and a rosin acid metal salt compound.
<4> The polylactic acid composition according to <2>, wherein the inorganic crystal nucleating agent is at least one selected from talc, kaolinite, montmorillonite, mica, and wollastonite.
<5> The polylactic acid composition according to any one of <2> to <4>, wherein the crystallization promoter is a polyglycerol fatty acid ester, a polyethylene glycol/polypropylene glycol copolymer, or both thereof.
<6> A method for producing a polylactic acid composition, including:

mixing a ring-opening polymerizable monomer, a compressible fluid, and a nucleating agent to thereby allow the ring-opening polymerizable monomer to ring-opening polymerize in the presence of a catalyst to generate a polymer; and

adding a crystallization promoter to the polymer, and mixing the crystallization promoter and the polymer together.

<7> The method for producing a polylactic acid composition according to <6>, wherein the nucleating agent is added in an amount of 0.1 parts by mass to 20 parts by mass relative to 100 parts by mass of the ring-opening polymerizable monomer.
<8> The method for producing a polylactic acid composition according to <6> or <7>, wherein the crystallization promoter is added in an amount of 0.1 parts by mass to 20 parts by mass relative to 100 parts by mass of the polymer.
<9> The method for producing a polylactic acid composition according to any one of <6> to <8>, wherein the compressible fluid contains carbon dioxide.
<10> An apparatus for producing a polylactic acid composition, including:

a polymerization unit configured to mix a ring-opening polymerizable monomer, a compressible fluid, and a nucleating agent to thereby allow the ring-opening polymerizable monomer to ring-opening polymerize in the presence of a catalyst to generate a polymer; and

a mixing unit configured to add a crystallization promoter to the polymer and mix the crystallization promoter and the polymer together.

### REFERENCE SIGNS LIST

1, 3, 5, 7, 11, 21, 27 Tank
2, 4, 22 Metering Feeder
6, 8, 12, 28 Metering Pump
9, 29 Contact Section
10 Liquid Transfer Pump
13, 33 Reaction Section
34 Pressure Adjustment Valve
100 Polymerization Reactor
100a Supply Unit
100b Main Body of Polymerization Reactor
P Polylactic Acid Composition

1. A polylactic acid composition, comprising:
polylactic acid, and
a ring-opening polymerizable monomer residue in a concentration of 100 ppm by mass to 5,000 ppm by mass,
wherein the polylactic acid composition has a weight average molecular weight of 100,000 or more but less than 300,000 as measured by gel permeation chromatography, a yellow index (YI) value of 5 or less, and a Charpy impact strength of 10 kJ/m² or more.

2. The polylactic acid composition according to claim 1, further comprising:
at least one of a nucleating agent and a crystallization promoter
wherein when present, the nucleating agent is at least one of an organic crystal nucleating agent and an inorganic crystal nucleating agent.

3. The polylactic acid composition according to claim 2, wherein the polylactic acid composition comprises the organic crystal nucleating agent, which is at least one of a phosphoric acid ester metal salt compound and a rosin acid metal salt compound.

4. The polylactic acid composition according to claim 2, wherein the polylactic acid composition comprises the inorganic crystal nucleating agent, which is at least one selected from the group consisting of talc, kaolinite, montmorillonite, mica, and wollastonite.

5. The polylactic acid composition according to claim 2, wherein the polylactic acid composition comprises the crystallization promoter, which is at least one of a polyglycerol fatty acid ester and a polyethylene glycol/polypropylene glycol copolymer.

6. A method for producing a polylactic acid composition, the method comprising:
mixing a ring-opening polymerizable monomer, a compressible fluid, and a nucleating agent to polymerize the ring-opening polymerizable monomer in the presence of a catalyst to generate a polymer; and
adding a crystallization promoter to the polymer, and mixing the crystallization promoter and the polymer together.

7. The method according to claim 6, wherein the nucleating agent is added in an amount of 0.1 parts by mass to 20 parts by mass relative to 100 parts by mass of the ring-opening polymerizable monomer.

8. The method according to claim 6, wherein the crystallization promoter is added in an amount of 0.1 parts by mass to 20 parts by mass relative to 100 parts by mass of the polymer.

9. The method according to claim 6, wherein the compressible fluid comprises carbon dioxide.

10. An apparatus for producing a polylactic acid composition, the apparatus comprising:
a polymerization unit configured to mix a ring-opening polymerizable monomer, a compressible fluid, and a nucleating agent to polymerize the ring-opening polymerizable monomer in the presence of a catalyst to generate a polymer; and
a mixing unit configured to add a crystallization promoter to the polymer and mix the crystallization promoter and the polymer together.
